(19) United States
(12) Patent Application Publication
(10) Pub. No.: US 2011/0048409 A1
(43) Pub. Date: Mar. 3, 2011

(54) SOLAR COLLECTORS AND METHODS

(75) Inventor: Hans-Peter Messmer, Vienna (AT)

(73) Assignee: Green Partners Technology Holdings GmbH, St. Gallen (CH)

(21) Appl. No.: 12/842,844

(22) Filed: Jul. 23, 2010

Related U.S. Application Data
(60) Provisional application No. 61/237,950, filed on Aug. 28, 2009.

(51) Int. Cl. F24J 2/24; B23P 15/26

(52) U.S. Cl. 126/663; 29/890.033

(57) ABSTRACT

In one instance, a solar collector uses vacuum to maintain or help maintain its components in an assembled position and to insulate or help insulate a plurality of thermal conduits. Curved members, edge members, and end caps combine to form an interior space and to provide a system with substantially no bending forces. An absorption-and-tensioning member traverses the interior space and keeps the curved members from collapsing when placed under partial or complete vacuum and helps absorb thermal energy. The edge members have seats for receiving the curved members that help firmly press the curved members into the seats to form a desired seal. Other solar collector systems, features, and methods are disclosed.

### RELATED APPLICATION

The present invention claims the benefit, under 35 USC §119(e), of the filing of U.S. Provisional Patent Application Ser. No. 61/237,950 entitled “Solar Collectors and Methods,” filed Aug. 28, 2009, which is incorporated herein by reference for all purposes.

### BACKGROUND

The present invention relates generally to solar collectors for capturing solar thermal energy, and more particularly, to improved solar collectors and methods.

Today there is an increased push to develop clean, renewable energy sources. One such effort involves the use of solar thermal collectors, or solar collectors. Solar collectors are intended to collect thermal energy by absorbing sunlight. Some solar collectors involve focusing solar energy using solar parabolic collectors, solar troughs, and solar towers. Other solar collectors use un-concentrated sunlight. Two commonly encountered solar collectors include flat plate collectors and vacuum tube collectors. These two types are used often for space heating and for domestic hot water production.

### BRIEF SUMMARY

Shortcomings with aspects of conventional solar collectors are addressed by the present invention as shown and described in a variety of illustrative, non-limiting embodiments herein. According to one illustrative, non-limiting embodiment, a solar collector for collecting thermal energy includes a first curved member, a second curved member, a plurality of edge members, and a plurality of end caps. The first curved member has a first end and a second end, a first longitudinal edge and a second longitudinal edge. The first curved member has a lateral cross section with an arc defined by a radius R₁. The second curved member has a first end and a second end, a first longitudinal edge and a second longitudinal edge. The second curved member has a lateral cross section with an arc defined by a radius R₂. One end cap of the plurality of end caps is associated with the first end of the first curved member and the first end of the second curved member and one end cap is associated with the second end of the first curved member and the second end of the second curved member. The solar collector further includes an internal absorption-and-tensioning member and a plurality of thermal conduits coupled to the absorption-and-tensioning member. Each edge members of the plurality of edge members has a first seat, a tension connection portion, and a second seat. The first seat and second seat each have a force-absorbing surface and a shelf surface with an angle β formed between the force-absorbing surface and the shelf surface. The angle β is less than ninety degrees)(90°). At least a portion of the internal absorption-and-tensioning member is coupled to the tension connection portion of the plurality of edge members. The first seat of at least one of the plurality of edge members receives the first longitudinal edge and at least one of the plurality of edge members receives the second longitudinal edge.

According to another illustrative, non-limiting embodiment, a method of manufacturing a solar collector includes the steps of forming a first curved member, forming a second curved member, forming a plurality of edge members, and forming a plurality of end caps. The first curved member is formed with a first end and a second end, a first longitudinal edge and a second longitudinal edge. The first curved member has a lateral cross section with an arc defined by a radius R₁. The second curved member is formed with a first end and a second end, a first longitudinal edge and a second longitudinal edge. The second curved member has a lateral cross section with an arc defined by a radius R₂. One end cap is coupled to the first end of the first curved member and the first end of the second curved member and another end cap is coupled to the second end of the first curved member and the second end of the second curved member. The method further includes forming an internal absorption-and-tensioning member and coupling a plurality of thermal conduits to the absorption-and-tensioning member. Each edge member of the plurality of edge member has a first seat, a tension connection portion, and a second seat. The first seat and second seat each have a force-absorbing surface and a shelf surface with an angle β formed between the force-absorbing surface and the shelf surface. The angle β is less than 90°. The method further includes coupling at least a portion of the internal absorption-and-tensioning member to the tension connection portion of the plurality of edge members. The first seat of at least one of the plurality of edge members receives the first longitudinal edge and at least one of the plurality of edge members receives the second longitudinal edge.

According to another illustrative, non-limiting embodiment, a method for assembling a solar collector includes the steps of providing a first curved member, second curved member, plurality of edge members, and plurality of end caps. The first curved member has a first end and a second end, a first longitudinal edge and a second longitudinal edge. The first curved member also has a lateral cross section with an arc defined by a radius R₁. The second curved member has a first end and a second end, a first longitudinal edge and a second longitudinal edge. The second curved member has a lateral cross section with an arc defined by a radius R₂. One end cap of the plurality of end caps is associated with the first end of the first curved member and the first end of the second curved member and one end cap is associated with the second end of the first curved member and the second end of the second curved member. The method further includes providing an internal absorption-and-tensioning member having a plurality of thermal conduits coupled to the absorption-and-tensioning member. Each edge member has a first seat, a tension connection portion, and a second seat. The first seat and second seat each have a force-absorbing surface and a shelf surface with an angle β formed between the force-absorbing surface and a shelf surface. The angle β is less than 90°. At least a portion of the internal absorption-and-tensioning member is coupled to the tension connection portion of the plurality of edge members. The method further includes disposing the first longitudinal edge of the first curved member into the first seat of at least one of the plurality of edge members and disposing the second longitudinal edge of the first curved member into the first seat of at least one of the plurality of edge members. The method also includes disposing the first longitudinal edge of the second curved member into the second seat of at least one of the plurality of edge members and disposing the second longitudinal edge of the second curved member into the second seat of at least one of the plurality of edge members. With these steps, an interior space is formed. The method also includes evacuating the interior space to form a sealed interior space.

According to another illustrative, non-limiting embodiment, a method of manufacturing a solar collector includes the steps of: forming a first curved member, forming a second curved member, forming a plurality of edge members, and forming a plurality of end caps. The method further includes associating the first curved member, second curved member, plurality of edge members, and plurality of end caps to form an interior space. The method also includes evacuating the interior space at least partially to maintain the interior space without fasteners.

Other features and advantages of the illustrative embodiments will become apparent with reference to the drawings and the detailed description that follow.

### BRIEF DESCRIPTION OF THE DRAWINGS

A more complete understanding of the present invention may be obtained by reference to the following Detailed Description when taken in conjunction with the accompanying Drawings wherein:

FIG. 1 is a schematic, perspective view of an illustrative, non-limiting embodiment of a solar collector;

FIG. 2 is a schematic, cross-sectional view of the illustrative solar collector of FIG. 1 taken along line 2-2;

FIG. 3 is a schematic, plan view of an illustrative, non-limiting embodiment of a first curved member;

FIG. 4 is a schematic, lateral cross-sectional view of the illustrative embodiment of the first curved member of FIG. 3;

FIG. 5 is a schematic, plan view of an illustrative, non-limiting embodiment of a second curved member;

FIG. 6 is a schematic, lateral cross-sectional view of the illustrative embodiment of the second curved member of FIG. 5;

FIG. 7 is a schematic, cross-sectional view of an illustrative, non-limiting embodiment of an edge member;

FIG. 8 is a schematic, plan view of an illustrative, non-limiting embodiment of a solar collector;

FIG. 9 is a schematic, side view of the solar collector of FIG. 8;

FIG. 10 is a schematic, perspective view of an illustrative first spherical segment member and a portion of an illustrative first curved member;

FIG. 11 is a schematic, plan view of the first spherical segment member and first curved member of FIG. 10;

FIG. 12 is a schematic, side view of the first spherical segment member and first curved member of FIGS. 10-11;

FIG. 13 is a schematic, end view of the first spherical segment member and first curved member of FIGS. 10-12; and

FIG. 14 is a schematic, perspective view of the first curved member, first spherical segment member, and of a second spherical segment member.

### DETAILED DESCRIPTION

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

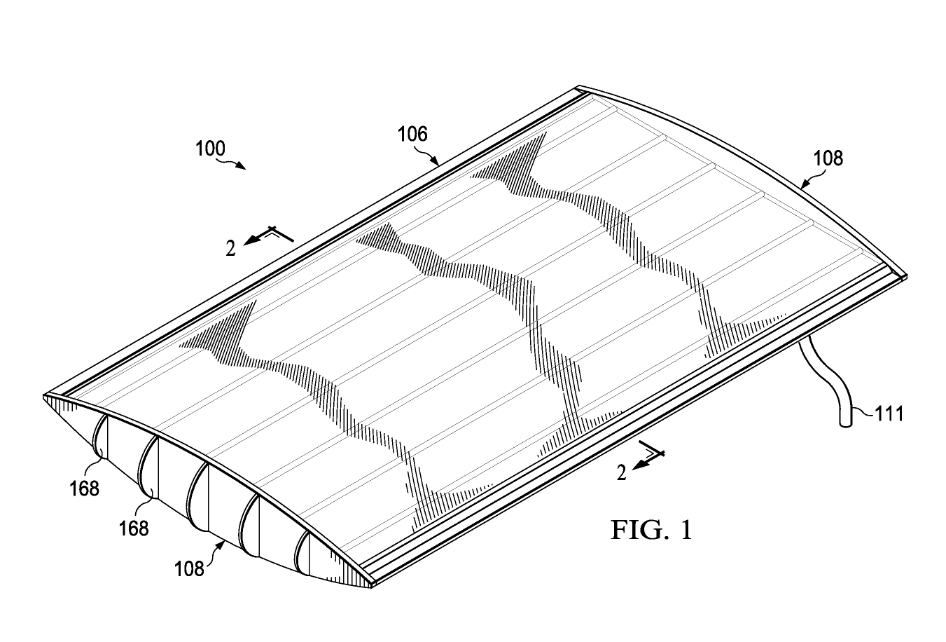

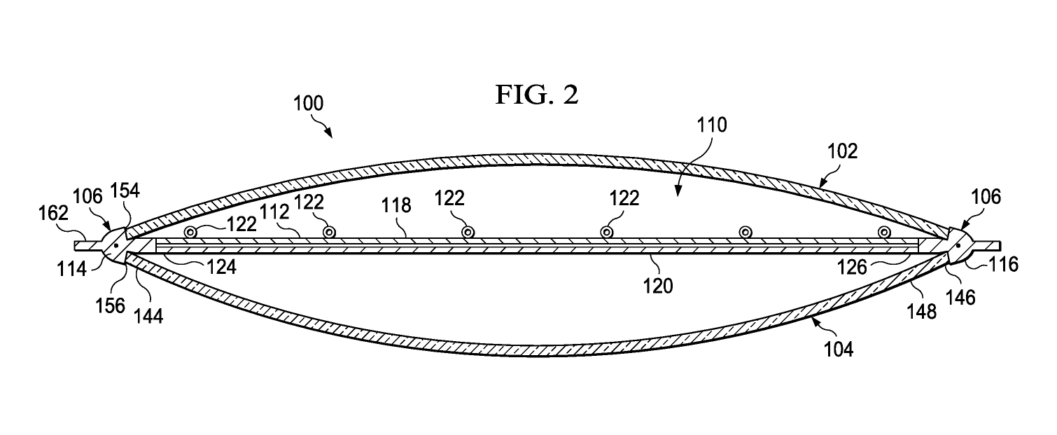

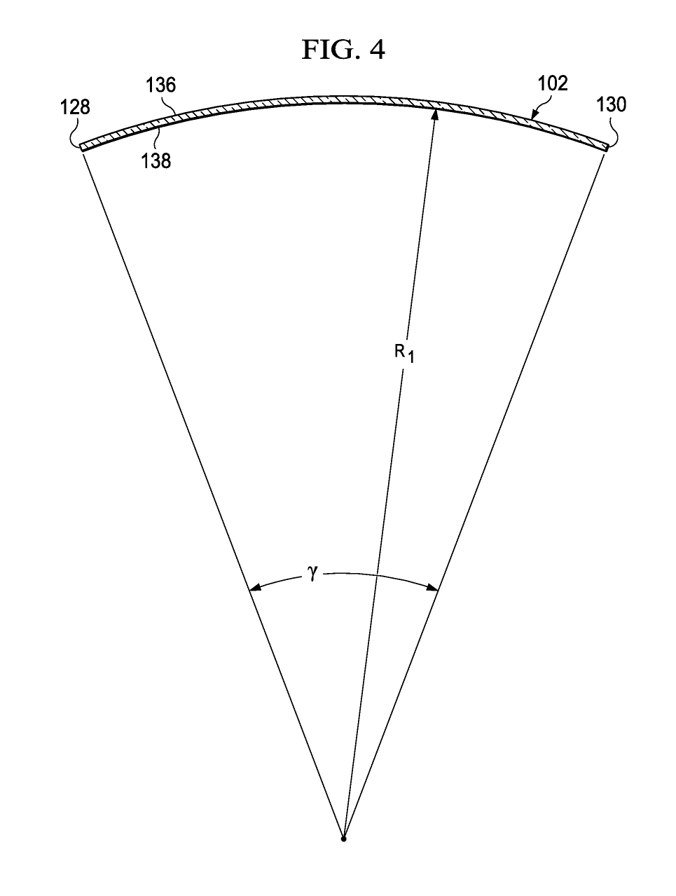

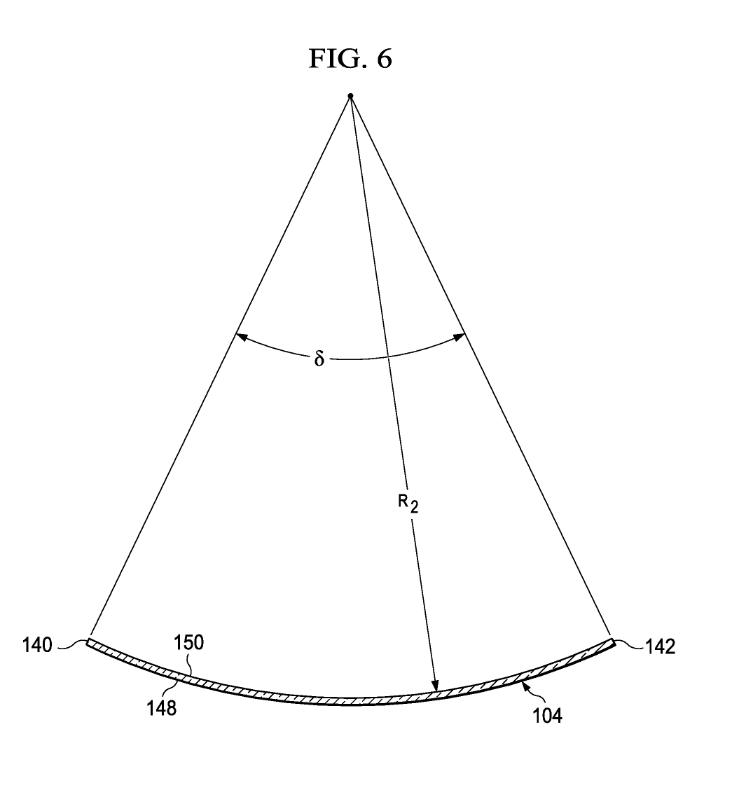

Referring now to FIGS. 1-7, and initially to FIGS. 1 and 2, an illustrative, non-limiting embodiment of a solar collector 100 is presented. The solar collector 100 includes a first curved member 102, a second curved member 104, a plurality of edge members 106, and a plurality of end caps 108. When assembled, the first curved member 102, second curved member 104, plurality of edge members 106, and end caps 108 form an interior space 110. An internal absorption-and-tensioning member 112 traverses the interior space 110 and holds a first edge member 114 and a second edge member 116 of the plurality of edge members 106 in relative position.

The solar collector 100 may include a vacuum port (not explicitly shown) to which a vacuum source 111 may be coupled to remove some or all of the fluid within the interior space 110. As the fluid is removed from the interior space 110, a complete seal is established to create a sealed interior space. The assembled solar collector 100 may be maintained using the vacuum or partial vacuum. Moreover, in some illustrative embodiments, the solar collector 100 may be assembled without any fasteners being required. It will be apparent that the solar collector 100 may be relatively easy to assemble. Furthermore, the solar collector may be less expensive to manufacture than conventional solar collectors. The solar collector 100 may be transported to a desired location in an unassembled state (a more compact form) and then assembled at the desired site.

The solar collector 100 may reflect less, or absorb more, sunlight than a tube collector because of the relatively flat nature of the first curved member 102 of the solar collector 100. The first curved member 102 may be flatter in some embodiments than the second curved member 104 in order to minimize reflection losses. The larger curve radius, however, may mean a higher compression stress on the material of the first curved member 102 in such instances. Light conducting pyramids and other devices may be added to the exterior of the first curved member 102.

The internal absorption-and-tensioning member 112 includes an absorber 118 and a tension member 120. A plurality of thermal tubes, or tubes 122, are coupled to the absorber 118 or formed integrally with the absorber 118. A space may be formed between the absorber 118 and the tension member 120. The space may be used to thermally isolate or partially isolate the absorber 118 and tension member 120 from each other. As will be explained in more detail below, the internal absorption-and-tensioning member 112, and in particular the tension member 120, holds tension between the first edge member 114 and second edge member 116 when a load is placed on the first curved member 102 and second curved member 104. The tension member 120 has a first end 124 and a second end 126. Without the internal absorption-and-tensioning member 112, and in particular the tension member 120, the curved members 102, 104 would typically collapse when placed under pressure. The tension member 120 may be made of a number of different materials capable of handling the tensile forces involved, including organic fiber material (e.g., a Kevlar® material), carbon fiber material, and resistant spring steel. The thickness of the tension member 120 will depend on the material and the forces to be carried. The tension member 120 or a portion of the tension member 120 may be made from a material, such as a Kevlar® material, that has minimal thermal expansion characteristics.

The absorber 118 may be placed underneath the tension member 120 (i.e., further from the sun than the tension member 120) or, as shown, may be placed above the tension member 120. Placing the absorber 118 above the tension member 120 facilitates capture of sunlight that passes through the first curved member 102. The absorber 118 may include a high-selective coating (not explicitly shown) to facilitate maximum absorption of sun radiation and to minimize the emission of thermal radiation. The selective coating may have a high absorption coefficient between the near infrared and the near ultraviolet range and a low emission coefficient in the mid-infrared range. The selective material coating may be applied to the lower surface of the absorber 118, both sides of the tension member 120, the inner surface of the second curved member 104, or any other surfaces desired so as to decrease the emission and absorption of infrared radiation produced by hot surfaces.

The plurality of tubes 122 that are coupled or formed integrally to the absorber 118 carry a working fluid. The thermal energy absorbed by the absorber 118 is delivered by way of thermal conduction to the plurality of tubes 122. The plurality of tubes 122 may directly absorb thermal energy as well. The working fluid within the plurality of tubes 122 absorbs thermal energy and may thereby transport thermal energy for storage or direct utilization. The working fluid may be any fluid suitable for receiving thermal energy, such as water, Glyco/water mixture, hydrocarbon oils, silicones, refrigerants, Dowtherm® fluid, etc. The plurality of tubes 122 may be formed from a highly conductive material, such as copper or aluminum. In other embodiments, the tubes 122 need not be highly conductive but may have a high surface area.

The absorber 118 and tubes 122 may be formed separately or integrally. In the latter embodiment, for example, the absorber 118 and tubes 122 may be extruded as an integral element. In another illustrative, non-limiting embodiment, the tubes 122 may be bonded to the absorber 118. In another illustrative, non-limiting embodiment, re-enforced plastics may be used for the absorber 118 and tubes 122. The tubes 122 may take numerous shapes and configurations, and in one illustrative, non-limiting embodiment, are formed as channels formed within the absorber 118.

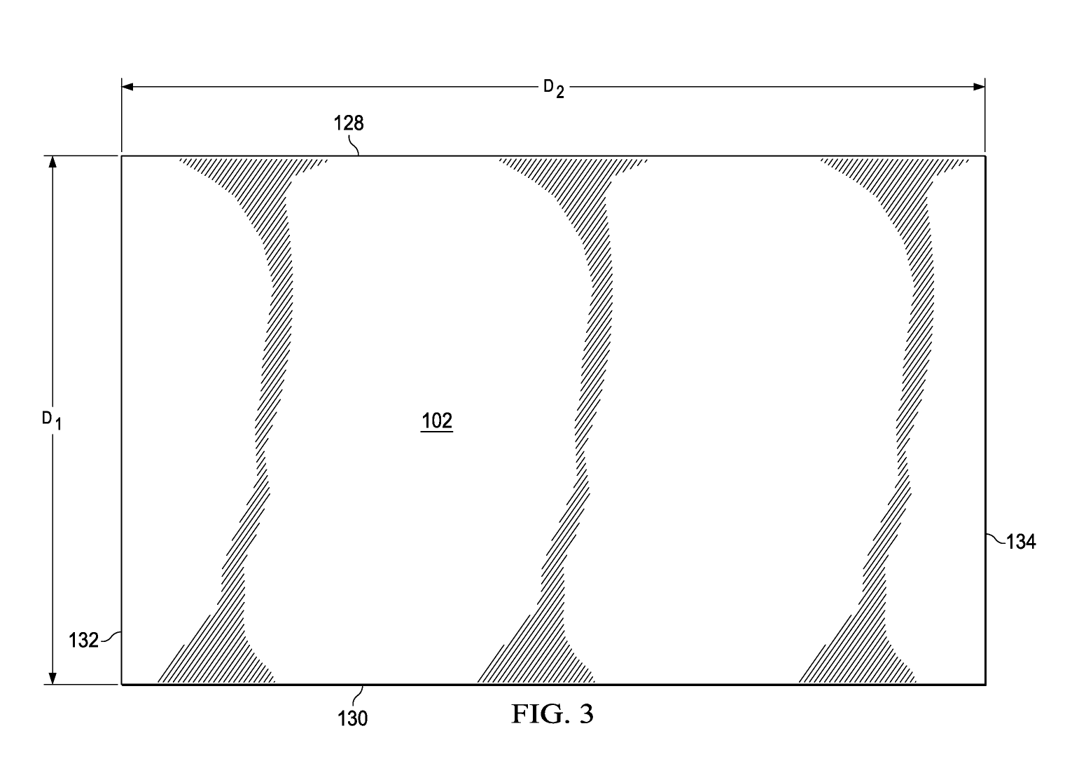

Referring now primarily to FIGS. 1-4, the first curved member 102 will be described in more detail. The first curved member 102 has a first longitudinal edge 128 and a second longitudinal edge 130. The first curved member 102 also has a first end 132 and a second end 134. The ends 132, 134 have a lateral dimension D₁. The longitudinal edges 128, 130 have a longitudinal dimension D₂. The first curved member 102 has an exterior surface 136 and an interior surface 138. The first curved member 102 is curved to form an arc defined by a radius R₁. The first curved member 102 has an arc angle γ. The first curved member 102 is formed from a translucent material and preferably is formed from glass. Depending on the specific application and material, the thickness of the first curved member 102 will vary. In one illustrative, non-limiting embodiment using glass, the first curved member 102 has a thickness between 3 mm and 10 mm. As used herein, “lateral” means in the general direction of the lateral dimension D₁ (or shorter dimension) and “longitudinal” means in the general direction of the longitudinal dimension D₂ (or longer dimension) for the embodiment shown in FIG. 3.

Similarly, as shown in FIGS. 1-2 and 5-6, the second curved member 104 has a first longitudinal edge 140 and a second longitudinal edge 142. The second curved member 104 also has a first end 144 and a second end 146. The second curved member 104 has an exterior surface 148 and an interior surface 150. The curve of the second curved member 104 is defined by an arc having a radius R₂ and an arc angle δ. The curvature of the first curved member 102 and second curved member 104 may be the same (R₁=R₂), the first curved member 102 may be flatter (R₁>R₂), or the first curved member 102 may be more curved (R₁<R₂). The second curved member 104 may be formed from numerous materials, such as a ceramic material, a low-grade glass, or metal, but glass is preferred. The curvature of the first curved member 102 and second curved member 104 is such that the orthogonal pressure force of the surrounding air on the exterior surfaces 136, 148 generates a substantially tangential force or a pure tangential force. Thus, the material from which the curved members 102, 104 are formed need only be stressed for compression.

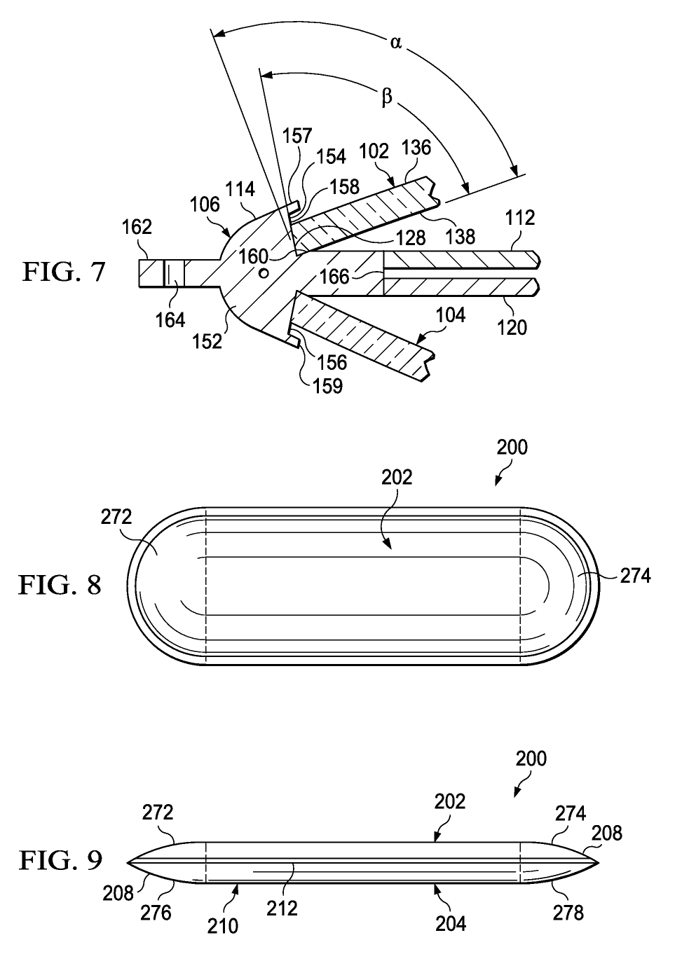

Referring now primarily to FIG. 7 a lateral cross-section of the first edge member 114 of the plurality of edge members 106 is presented. The first edge member 114 has an edge member body 152 that is formed with a first seat 154 and a second seat 156. The first seat 154 is sized and configured to receive the first longitudinal edge 128 (or second longitudinal edge 130) of the first curved member 102. Similarly, the second seat 156 is sized and configured to receive a longitudinal edge (e.g., the first longitudinal edge 140 or second longitudinal edge 142) of the second curved member 104.

The first seat 154 includes a force-absorbing surface 158 and a shelf surface 160. The angle formed between the force-absorbing surface 158 and the shelf surface 160 is an angle β that is preferably less than 90°. Angle α is 90° from the shelf surface 160 in FIG. 7 and β is less than 90°. Angle β may be, for example, any angle between 90° and 70°, e.g., 90°, 89°, 88°, 87°, 86°, 85°, 75° or less. While integral angles are given as example, it should be understood that any angle over the range may be used, e.g., 88.743°. The end of the curved members 102, 104 may also be formed with an angle β so that the end sits perfectly within the seat, e.g., the first seat 154.

The edge body member 152 may be formed with a first protrusion 157 formed as a protrusion from a portion of the force-absorbing surface 158. The first protrusion 157 together with the force-absorbing surface 158 and shelf surface 160 forms a slot for receiving and maintaining the first longitudinal edge 128 (or second longitudinal edge 130) of the first curved member 102. As noted, the force-absorbing surface 158 and shelf surface 160 form an angle β that is less than 90° to help push the first end 132 into the first seat 154. The first protrusion 157 may be spaced with respect to the exterior surface 136 of the first curved member 102 or may have minimal clearance. The first protrusion 157 may help prevent the first curved member 102 from sliding out when a bending force is applied to a flange portion 162 or when first curved member 102 otherwise is urged to move away from the shelf surface 160.

With respect to the first curved member 102, the interior surface 138 near the first longitudinal edge 128 (or second longitudinal edge 130) is placed in the first seat 154 and, in particular, the interior surface 138 is placed on the shelf surface 160 and the first longitudinal edge 128 (or second longitudinal edge 130) is placed near to or adjacent the force-absorbing surface 158. Because angle β is less than 90°, as the vacuum is applied to the interior space 110, the first curved member 102 is pulled more tightly into the first seat 154 thereby improving the sealing characteristic. A ductile material may be used to form the first seat 154 or may be added to the first seat 154 to further increase the sealing ability of the first seat 154.

The second seat 156 is analogous to the first seat 154. A second protrusion 159 is analogous to the first protrusion 157. The operation of the second seat 156 with respect to the second curved member 104 is also analogous to the first seat 154. In addition, while the first edge member 114 is described above, it should be understood that the second edge member 116 is analogous to the first edge member 114.

The first edge member 114 also may include the flange portion 162, or mount, formed as part of the edge member body 152. The flange portion 162 may further include an aperture 164. The flange portion 162 and the aperture 164 may be used to attach the first edge member 114 to a mounting structure, e.g., a frame or pedestal, to hold the solar collector 100 at a desired site. A portion of the first edge member 114, e.g., a flange portion 162, may further include a tension connection portion 166 for coupling to the internal absorption-and-tensioning member 112, tension member 120, or absorber 118. As used herein, “or” does not require mutual exclusivity. The edge members, e.g., the first edge member 114, may be formed on all the edges or a portion of the edges.

As shown in FIG. 1, the plurality of end caps 108 provides a seal to the lateral ends and may be coupled to the plurality of edge members 106. A plurality of reinforcement members 168 may be included to further strengthen the plurality of end caps 108. The end caps 108 may be any device for providing a seal on the lateral ends as shown. For example, the end caps 108 may be sufficiently strong vertical members or more preferably may be formed as spherical segment members as will be described further below in connection with FIGS. 8-14. The end caps 108 may be formed integrally with the curved members 102, 104 or may be coupled. As used herein, the term “coupled” includes coupling via a separate object and includes direct coupling. The term “coupled” also encompasses two or more components that are continuous with one another by virtue of each of the components being formed from the same piece of material or integrally formed. Also, the term “coupled” may include chemical (such as via a chemical bond), mechanical (such as with fasteners), thermal, or electrical coupling.

In operation, the components for forming solar collector 100 may be transported to a desired location. The internal absorption-and-tensioning member 112, if not already coupled to the first edge member 114 and second edge member 116, may be so coupled. The coupling may occur by any known technique, such as welding, mechanical fasteners, mating notches, gluing or other technique. The first curved member 102 may be placed within the first seat 154 and the second curved member 104 may be placed in the second seat 156 and maintained in position. The end caps 108 may be coupled if not already formed integrally with or otherwise coupled to the curved members 102, 104. At this point, the interior space 110 has been formed and the vacuum source 111 may be used to evacuate the interior space 110 completely or partially.

As the interior space 110 is evacuated, the curved members 102, 104 are pulled tightly into the seats 154, 156 and a sealed interior space is formed. The sealing of the interior space 110 in this way may hold all of these components in their respective place without requiring any fasteners. In other embodiments, fasteners may be used to augment or initially hold these major components.

As the interior space 110 is evacuated, the first curved member 102 and second curved member 104 tend to be urged towards each other and want to flatten out. This action places the internal absorption-and-tensioning member 112 into tension. The internal absorption-and-tensioning member 112 prevents the solar collector 100 from collapsing. As the pressure differential develops between the evacuated interior space 110 and the ambient outside pressure, the solar collector 100 transforms compression forces that develop into tangential forces.

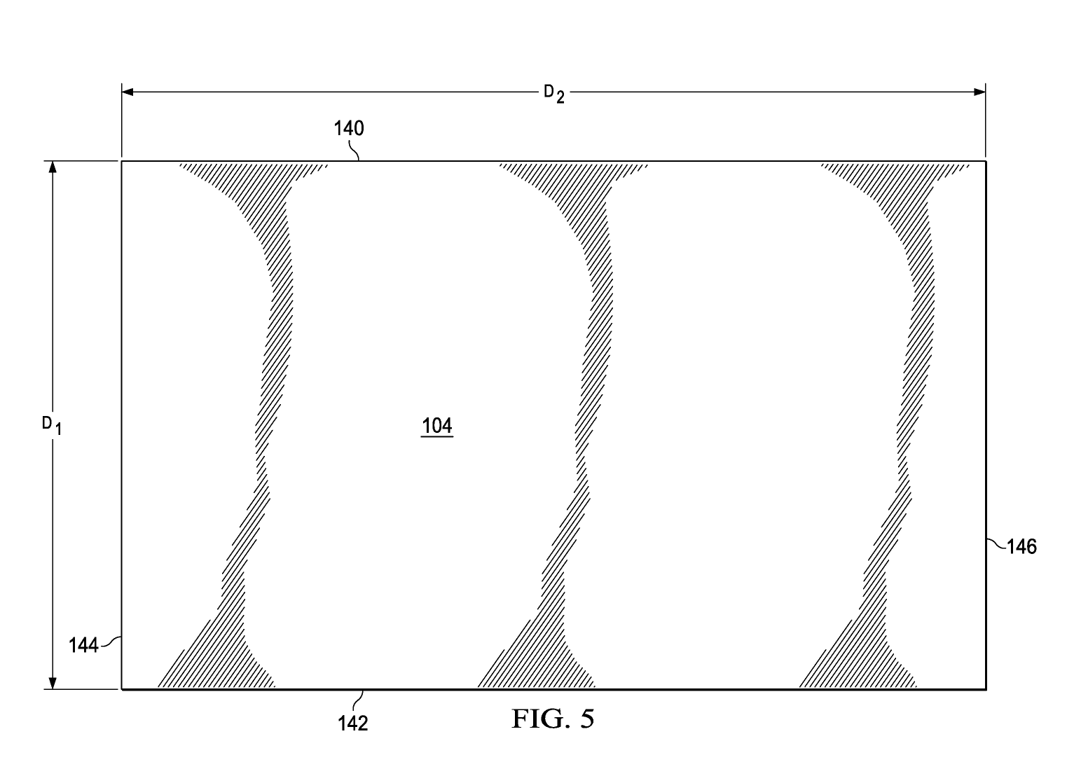

The first curved member 102 and second curved member 104 may be readily manufactured, or produced, in large quantities. If the curved members 102, 104 are formed as glass sheets, the curved members 102, 104 may be produced by rolling glass sheets into an arc shaped cross-sectional form. The rolled glass sheets are formed with a desired longitudinal length. In this manner, long collectors may be produced. In some situations, e.g., solar power farms, it may be desirable to have a large quantity of long, relatively slender solar collectors 100. For example, with respect to FIGS. 3 and 5, and given the longitudinal dimension D₂ and lateral dimension D₁, the solar collectors 100 may have an aspect ratio (longer dimension/shorter dimension) ranging from 1 to 100, and more typically 4 to 20. The lateral dimension may be any size, but in one illustrative, non-limiting embodiment is in the range of 1 to 10 meters.

The tension member 120 carries tension and prevents the first curved member 102 and second curved member 104 from collapsing. As such, the tension member 120 may face fairly high stresses. For example, with reference to FIGS. 3-6, in an illustrative, non-limiting example in which the width, D₁, is 1 meter, the arc angle γ is 45°, the arc angle δ is 60°, the stress carried by the tension member 120 would be greater than 200 kN/m². If spring steel, which has a resistance to stress greater than 2500 N/mm², is used in this example for the tension member 120, the tension member 120 would theoretically need only be 0.1 mm in thickness. It should be apparent that numerous materials and parameters may be selected for the tension member 120 to carry the design loads for a particular solar collector.

Referring now primarily to FIGS. 8 and 9, another illustrative, non-limiting embodiment of a solar collector 200 is presented. The solar collector 200 has a first curved member 202 and a second curved member 204. Analogous to the solar collector 100 of FIGS. 1-7, the first curved member 202 and the second curved member 204 together with a plurality of end caps define an interior space 210. An internal absorption-and-tensioning member 212 transverses the interior space 210.

A plurality of end caps 208 includes a first spherical segment member 272, a second spherical segment member 274, a third spherical segment member 276 and a fourth spherical member 278. These spherical segment members 272, 274, 276, 278 are formed as sections of a sphere, or ball. The first and second spherical segment members 272 and 274 are segments of a sphere having a radius equivalent to the curvature of the radius R₁ of the first curved member 202. Similarly, the third and fourth spherical segment members 276 and 278 are formed as sections of the surface of a sphere with a radius R₂ equivalent to the curvature of the second curved member 204. In this way, the spherical segment members 272, 274, 276, 278 preferably only produce tangential loads that are delivered to the curved members 202, 204. As such, bending forces and other forces may be substantially or altogether avoided.

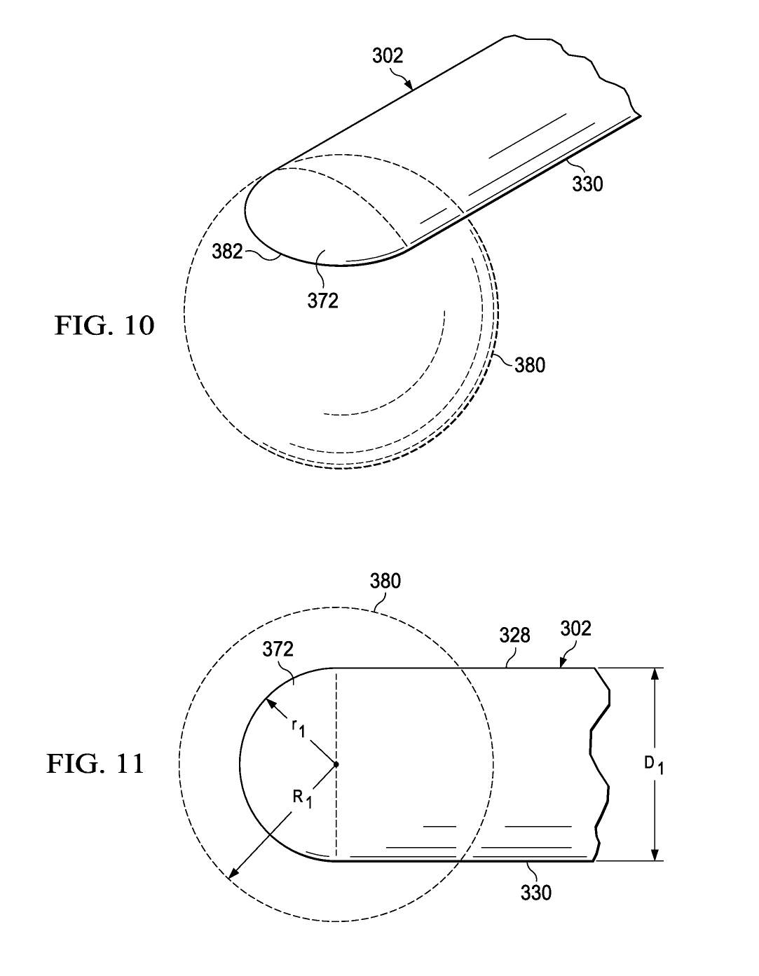

Referring now primarily to FIGS. 10-14, one illustrative, non-limiting embodiment of a first curved member 302, an associated first spherical segment member 372, and a second spherical segment member 374 are presented. Referring initially to FIG. 10, the curvature of the first curved member 302 and the first spherical segment member 372 may be described by visualizing a sphere 380 having a radius R₁. The external surface of the sphere 380 matches the curvature of the interior surface of the first curved member 302 as shown well in FIGS. 10 and 13.

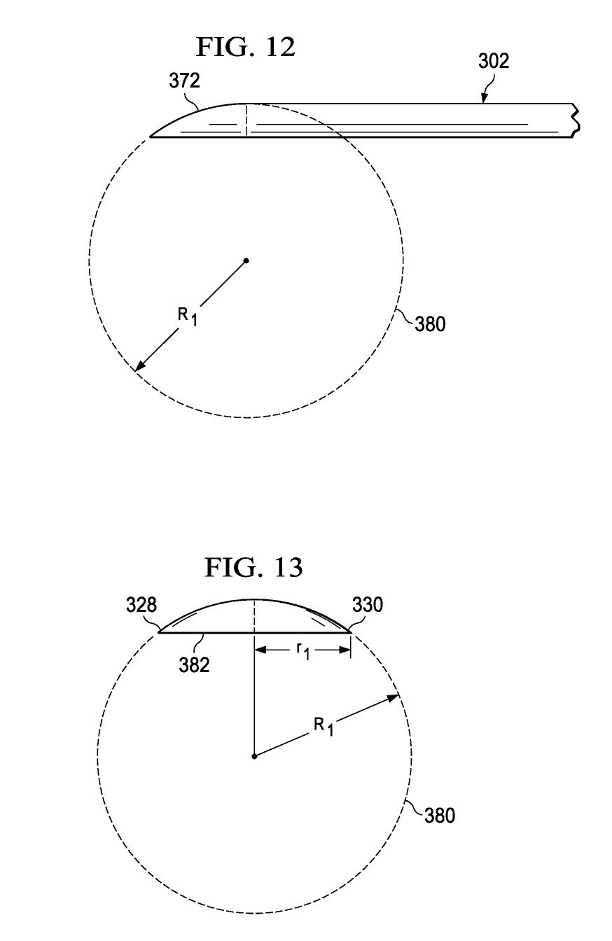

The first spherical segment member 372 is shaped as a spherical segment that matches the sphere 380 as shown best in FIGS. 10 and 12. A lower edge 382 of the first spherical segment member 372 is defined by a footprint radius r₁ that substantially equals one-half a distance D₁ between a first longitudinal edge 328 and a second longitudinal edge 330. The first spherical segment member 372 may be formed integrally with the first curved member 302 or the first spherical segment member 372 may be coupled to the first curved member 302. As seen clearly in FIGS. 12 and 13, the first spherical segment member 272 conforms to the radius R₁ of the sphere 380 in cross-sections taken in two orthogonal planes, i.e., a longitudinal cross-section as suggested by FIG. 12 and a lateral cross-section as suggested by FIG. 13.

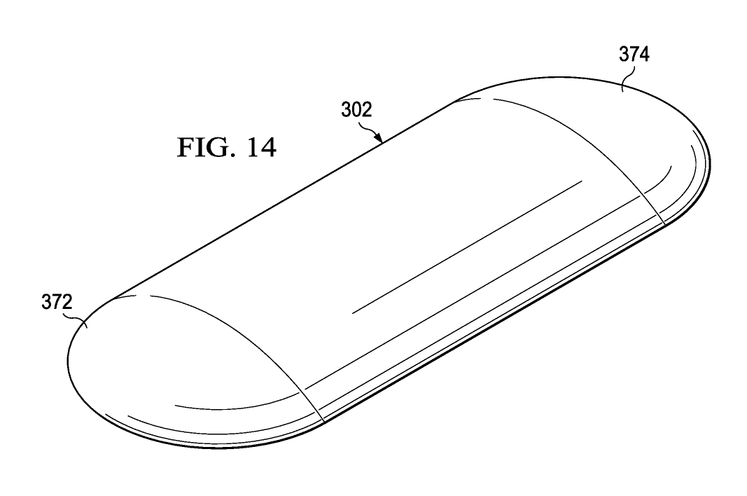

The second spherical segment member 374 is formed analogously to the first spherical segment member 372. The completed first curved member 302 and the spherical segment members 372, 374 are shown in FIG. 14. It should be understood that a third and fourth spherical segment members on a second curved member, e.g., the second curved member 104 in FIGS. 1-7, would be formed in analogous fashion with a sphere matching the curvature or radius R₂ of the second curved member.

In an alternative embodiment, the internal absorption-and-tensioning member, e.g., internal absorption-and-tensioning member 112 of FIG. 2, may include a tension member and absorber formed as an integral unit. In other words, the absorber and tubes may carry the tension of the tensile forces or separate components formed as an integral piece. In one illustrative, non-limiting embodiment, the internal absorption-and-tensioning member is formed from a material that is tension resistant and has a low thermal transfer coefficient, such as from a Kevlar® material, carbon composite, Invar steel (steel allow with low thermal expansion coefficient), etc.

In another illustrative, non-limiting embodiment, the interior space, e.g., interior space 110 of FIG. 1, of the solar collector need not be completely evacuated for a particular application. In such instances, the second curved member may be readily modified to use less expensive materials or may include additional thermal insulation applied to the exterior of the second curved member. Moreover, if the pressure differential (between the exterior and the interior space) is not great, the tension member may simply be metal cables or fibers added to the absorber or simply the absorber itself. In another alternative embodiment, the absorber is placed below the tension member and the tension member is made of a transparent material.

Although the present invention and its advantages have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection with any one embodiment may also be applicable to any other embodiment.

We claim:

1. A solar collector comprising:
a first curved member having a first end and a second end, a first longitudinal edge and a second longitudinal edge, the first curved member having a lateral cross section with an arc defined by a radius R₁;
a second curved member having a first end and a second end, a first longitudinal edge and a second longitudinal edge, the second curved member having a lateral cross section with an arc defined by a radius R₂;
a plurality of end caps, wherein one end cap is associated with the first end of the first curved member and the first end of the second curved member and one end cap is associated with the second end of the first curved member and the second end of the second curved member;
an internal absorption-and-tensioning member;
a plurality of thermal conduits coupled to the internal absorption-and-tensioning member;
a plurality of edge members, each edge member having a first seat, a tension connection portion, and a second seat, wherein the first seat and second seat each have a force-absorbing surface and a shelf surface with an angle β formed between the force-absorbing surface and the shelf surface and wherein the angle β is less than 90′; and
wherein at least a portion of the internal absorption-and-tensioning member is coupled to the tension connection portion of the plurality of edge members and wherein the first seat of at least one of the plurality of edge members receives the first longitudinal edge and at least one of the plurality of edge members receives the second longitudinal edge.

2. The solar collector of claim 1, wherein the plurality of end caps comprises:
a first spherical segment member coupled to the first end of the first curved member;
a second spherical segment member coupled to the second end of the first curved member;
a third spherical segment member coupled to the first end of the second curved member; and
a fourth spherical segment member coupled to the second end of the second curved member.

3. The solar collector of claim 1, wherein the internal absorption-and-tensioning member comprises a metal sheet and an absorber.

4. The solar collector of claim 1, wherein the internal absorption-and-tensioning member comprises a metal sheet coupled to an absorber.

5. The solar collector of claim 1, wherein the plurality of end caps comprises:
a first spherical segment member coupled to the first end of the first curved member, wherein the first spherical segment member comprises a member formed as a portion of a sphere having a radius R₁ and having footprint radius r₁ that substantially equals one half a distance D₁ between the first longitudinal edge and second longitudinal edge of the first curved member;
a second spherical segment member coupled to the second end of the first curved member, wherein the second spherical segment member comprises a member formed as a portion of a sphere having a radius R₁ and having footprint radius r₁ that substantially equals one half a distance D₁ between the first longitudinal edge and second longitudinal edge of the first curved member,
a third spherical segment member coupled to the first end of the second curved member, wherein the third spherical segment member comprises a member formed as a portion of a sphere having a radius R₂ and having footprint radius r₂ that substantially equals one half a distance between the first longitudinal edge and second longitudinal edge of the first curved member; and
a fourth spherical segment member coupled to the second end of the second curved member, wherein the fourth spherical segment member comprises a member formed as a portion of a sphere having a radius R₂ and having footprint radius r₂ that substantially equals one half a distance between the first longitudinal edge and second longitudinal edge of the first curved member.

6. The solar collector of claim 5, wherein R₁=R₂.

7. The solar collector of claim 5, wherein R₁>R₂.

8. The solar collector of claim 5, wherein R₁<R₂.

9. The solar collector of claim 1, wherein the first curved member and second curved member in combination with the plurality of edge members and plurality of end caps form a sealed interior space that is configured to hold a vacuum.

10. The solar collector of claim 1, wherein the angle β is less than 90° and greater than 75°.

11. The solar collector of claim 5, wherein the first spherical segment member is formed integrally with the first curved member and the second spherical segment member is formed integrally with the first curved member.

12. The solar collector of claim 5, wherein the first spherical segment member is formed integrally with the first curved member, the second spherical segment member is formed integrally with the first curved member, the third spherical segment member is formed integrally with the second curved member, and the fourth spherical segment member is formed integrally with the second curved member.

13. The solar collector of claim 1 wherein the first curved member and second curved member have an aspect ratio greater than 3 and wherein D₁ is greater than 2 meters.

14. A method of manufacturing a solar collector comprising the steps of:
forming a first curved member having a first end and a second end, a first longitudinal edge and a second longitudinal edge, the first curved member having a lateral cross section with an arc defined by a radius R₁;
forming a second curved member having a first end and a second end, a first longitudinal edge and a second longitudinal edge, the second curved member having a lateral cross section with an arc defined by a radius R₂;
forming a plurality of end caps, wherein one end cap is coupled to the first end of the first curved member and the first end of the second curved member and another end cap is coupled to the second end of the first curved member and the second end of the second curved member;
forming an internal absorption-and-tensioning member;
coupling a plurality of thermal conduits to the internal absorption-and-tensioning member;
forming a plurality of edge members, each edge member having a first seat, a tension connection portion, and a second seat, wherein the first seat and second seat each have a force-absorbing surface and a shelf surface with an angle β formed between the force-absorbing surface and the shelf surface and wherein the angle β is less than 90 degrees; and
coupling at least a portion of the internal absorption-and-tensioning member to the tension connection portion of the plurality of edge members and wherein the first seat of at least one of the plurality of edge members receives the first longitudinal edge and at least one of the plurality of edge members receives the second longitudinal edge.

15. The method of manufacturing a solar collector of claim 14, wherein the step of forming the plurality of end caps comprises the steps of:
forming a first spherical segment member coupled to the first end of the first curved member;
forming a second spherical segment member coupled to the second end of the first curved member;
forming a third spherical segment member coupled to the first end of the second curved member; and
forming a fourth spherical segment member coupled to the second end of the second curved member.

16. The method of manufacturing a solar collector of claim 14, wherein the step of forming an internal absorption-and-tensioning member comprises providing a metal sheet and coupling an absorber with the metal sheet.

17. The method of manufacturing a solar collector of claim 14, wherein the step forming the plurality of end caps comprises:
forming a first spherical segment member, wherein the first spherical segment member comprises a member formed as a portion of a sphere having a radius R₁ and having footprint radius r₁ that substantially equals one half a distance D₁ between the first longitudinal edge and second longitudinal edge of the first curved member;
coupling the first spherical segment member to the first end of the first curved member;
forming a second spherical segment member, wherein the second spherical segment member comprises a member formed as a portion of a sphere having a radius R₁ and having footprint radius r₁ that substantially equals one half a distance D₁ between the first longitudinal edge and second longitudinal edge of the first curved member;
coupling the second spherical segment member to the second end of the first curved member;
forming a third spherical segment member, wherein the third spherical segment member comprises a member formed as a portion of a sphere having a radius R₂ and having footprint radius r₂ that substantially equals one half a distance between the first longitudinal edge and second longitudinal edge of the first curved member;
coupling the third spherical segment member to the first end of the second curved member;
forming a fourth spherical segment member wherein the fourth spherical segment member comprises a member formed as a portion of a sphere having a radius R₂ and having footprint radius r₂ that substantially equals one half a distance between the first longitudinal edge and second longitudinal edge of the first curved member; and
coupling the fourth spherical segment member to the second end of the second curved member.

18. The method of manufacturing a solar collector of claim 17, wherein R₁=R₂.

19. The method of manufacturing a solar collector of claim 17, wherein R₁>R₂.

20. The method of manufacturing a solar collector of claim 17, wherein R₁<R₂.

21. The method of manufacturing a solar collector of claim 14, wherein the first curved member and second curved member in combination with the plurality of edge members and plurality of end caps form a sealed interior space that is configured to hold a vacuum.

22. The method of manufacturing a solar collector of claim 14, wherein the angle β is between 75° and 90°.

23. The method of manufacturing a solar collector of claim 17, wherein the step of forming a first spherical segment member comprises forming the first spherical segment member integrally with the first curved member and the step of forming the second spherical segment member comprises forming the second spherical segment member integrally with the first curved member.

24. The method of manufacturing a solar collector of claim 17, wherein the step of forming a first spherical segment member comprises forming the first spherical segment member integrally with the first curved member and the step of forming the second spherical segment member comprises forming the second spherical segment member integrally with the first curved member, the step of forming the third spherical segment member comprises forming the third spherical segment integrally with the second curved member, and the step of forming the fourth spherical segment member comprises forming the fourth spherical segment member integrally with the second curved member.

25. A method for assembling a solar collector, the method comprising the steps of:
providing a first curved member having a first end and a second end, a first longitudinal edge and a second longitudinal edge, the first curved member having a lateral cross section with an arc defined by a radius R₁;
providing a second curved member having a first end and a second end, a first longitudinal edge and a second longitudinal edge, the second curved member having a lateral cross section with an arc defined by a radius R₂;
providing a plurality of end caps, wherein one end cap is associated with the first end of the first curved member and the first end of the second curved member and another end cap is associated with the second end of the first curved member and the second end of the second curved member;
providing an internal absorption-and-tensioning member having a plurality of thermal conduits coupled to the internal absorption-and-tensioning member;
providing a plurality of edge members, each edge member having a first seat, a tension connection portion, and a second seat, wherein the first seat and second seat each have a force-absorbing surface and a shelf surface with an angle β formed between the force-absorbing surface and a shelf surface and wherein the angle β is less than 90°, wherein at least a portion of the internal absorption-and-tensioning member is coupled to the tension connection portion of the plurality of edge members;
disposing the first longitudinal edge of the first curved member into the first seat of at least one of the plurality of edge members;
disposing the second longitudinal edge of the first curved member into the first seat of at least one of the plurality of edge members;
disposing the first longitudinal edge of the second curved member into the second seat of at least one of the plurality of edge members;
disposing the second longitudinal edge of the second curved member into the second seat of at least one of the plurality of edge members, whereby an interior space is formed; and
evacuating the interior space to form a sealed interior space.

26. The method for assembling a solar collector of claim 25, wherein the method comprises assembling the solar collector with no fasteners.

27. A method of manufacturing a solar collector comprising the steps of:
forming a first curved member;
forming a second curved member;
forming a plurality of edge members;
forming a plurality of end caps;
associating the first curved member, second curved member, plurality of edge members, and plurality of end caps to form an interior space; and
evacuating the interior space at least partially to maintain the interior space without fasteners.
